(19) United States
(12) Patent Application Publication
(10) Pub. No.: US 2007/0235605 A1
(43) Pub. Date: Oct. 11, 2007

(54) Instrument stand securement device

(76) Inventor: Jacob Voelz, Glendale, CA (US)

Correspondence Address: JAMES E. BRUNTON, ESQ., P. O. BOX 29000, GLENDALE, CA, 91209, US

(21) Appl. No.: 11/400,471

(22) Filed: Apr. 6, 2006

(51) Int. Cl. A47B 91/00; F16M 11/20

(52) U.S. Cl. 248/188.8

(57) ABSTRACT

A securement device for securing an instrument holding stand, such as a tripod, on a bandstand, that includes a generally planar, yieldably deformable member that has an elongated segment having an upper surface for engagement by the extremity of one the legs of tripod; a first outwardly extending segment foldably connected to the elongated segment for circumscribing of one of the legs of the instrument holding tripod; and a second outwardly extending segment foldably connected to the elongated segment for circumscribing a portion of one of the legs of the tripod and for overlying and releasably gripping a portion of the first outwardly extending segment in a manner to hold it in position about the tripod leg.

### BACKGROUND OF THE INVENTION

1. Field of the Invention

The present invention relates generally to securement devices. More particularly, the invention concerns a securement device that can be attached to the legs of an instrument-supporting stand, such as a percussion instrument supporting tripod, to hold the stand in position during the musical performance.

2. Discussion of the Prior Art

A common problem experienced by musicians is the annoying movement of the instrument-supporting stand as the instrument is played during the musical performance. The problem is particularly pronounced for musicians playing percussion instruments, such as drum sets that include drums, cymbals, kick drums and the like. The thrust of the present invention is to provide a novel securement device that will solve this annoying problem.

A number of different approaches have been suggested in the past for securing instrument-supporting stands. By way of example, the prior art patent to Cady Pat. No. 5,994,634 concerns anchoring devices for percussion musical instruments. The Cady devices, which are disposed in clamping relationship with a removable rug, comprise generally “U”-shaped anchoring members, which are located where desired by the player and receive the legs of the percussive instruments thereby anchoring them in place and preventing movement when the instruments are struck.

U.S. Pat. No. 4,441,398 issued to Baker discloses an anchor for a bass drum or similar percussion instrument having a barrier secured to one end of a portable friction mat of a size capable of receiving the instrument at the barrier end and the player at the other end.

The prior art patent to Ryan, U.S. Pat. No. 3,096,677, discloses a non-slip drum holder that will not permit a drum to slip from its original placed position on a band stand or the like. The Ryan drum holder comprises four flat pads of non-slip material, each of the pads being adjacent to two others and each of the two pads being hinged to two of the pads so as to permit their being folded together in a package the size of one of the four flat pads. One of the flat pads has an L-shaped support along the peripheral edge thereof and a second L-shaped support on the surface. A pad adjacent the pad has an L-shaped opening therein adapted to receive the second mentioned L-shaped support on the one flat pad when the holder is completely folded together.

As will become apparent from the description that follows, the present invention provides a simple, easy to use method for anchoring instrument stands of various types, including percussion instrument holding tripods.

### SUMMARY OF THE INVENTION

By way of summary, the securement device of the present invention for securing an instrument holding stand, such as a tripod, on a bandstand, comprises a generally planar, yieldably deformable member that includes an elongated segment having an upper surface for engagement by the extremity of one the legs of tripod; a first outwardly extending segment foldably connected to the elongated segment for circumscribing of one of the legs of the instrument holding tripod; and a second outwardly extending segment foldably connected to the elongated segment for circumscribing a portion of one of the legs of the tripod and for overlying and releasably gripping a portion of the first outwardly extending segment in a manner to hold it in position about the tripod leg.

With the foregoing in mind, it is an object of the present invention to provide securement devices for securing in position and instrument holding stand for holding instruments, such as percussion instruments that are easy to use and can be expeditiously located where desired by the musician.

Another object of the invention is to provide securement devices of the aforementioned character that are of simple construction and can be used to secure in position instrument holding stands, such as instrument holding tripods of various constructions.

Another object of the invention is to provide securement devices of the class described that can easily releasably affixed to the bandstand carpet in a manner to enable the musician to expeditiously locate the instrument holding stand at a location convenient to the musician and to easily move the instrument holding stand as may be desired.

Another object of the invention is to provide securement devices of the class described that can be quickly and easily connected to a leg of an instrument holding stand and are effective in preventing the instrument holding stand from moving as the instrument is played in a manner that produces forces tending to move the instrument holding stand in a direction away from the player.

Another object of the invention is to provide securement devices of the character described in the preceding paragraphs that are reliable in use and can be inexpensively manufactured.

The foregoing as well as other outtakes of the invention will become more apparent from the description which follows.

### BRIEF DESCRIPTION OF THE DRAWINGS

FIG. 1 is a generally perspective diagrammatic view illustrating the securement devices of the invention in position for attachment to the legs of an instrument-supporting tripod.

FIG. 2 is a greatly enlarged, generally perspective illustrative view of one of the securement devices of the invention.

FIG. 3 is a top plan view of the instrument tripod illustrating the attachment of the securement devices to the legs of the tripod.

FIG. 4 is a greatly enlarged cross-sectional view taken along lines 4-4 of FIG. 3.

FIG. 5 is a cross-sectional view taken along lines 5-5 of FIG. 4.

FIG. 6 is a greatly enlarged view of the area designated in FIG. 5 as “6-6”.

FIG. 7 is a cross-sectional view taken along lines 7-7 of FIG. 4.

FIG. 8 is an enlarged cross-sectional view of the area designated in FIG. 7 as “8-8”.

FIG. 9 is an enlarged cross-sectional view of the area designated in FIG. 4 as “9-9”.

FIG. 10 is an enlarged side elevation view of one of the tripod legs showing the securement device in position about the leg.

FIG. 11 is a cross-sectional view taken along lines 11-11 of FIG. 10.

FIG. 12 is an enlarged cross-sectional view of the area designated in FIG. 11 as “12-12”.

FIG. 13 is a cross-sectional view taken along lines 13-13 of FIG. 10.

FIG. 14 is an enlarged cross-sectional view of the area designated in FIG. 13 as “14-14”.

FIG. 15 is an enlarged cross-sectional view of the area designated in FIG. 10 as “15-15”.

### DESCRIPTION OF THE INVENTION

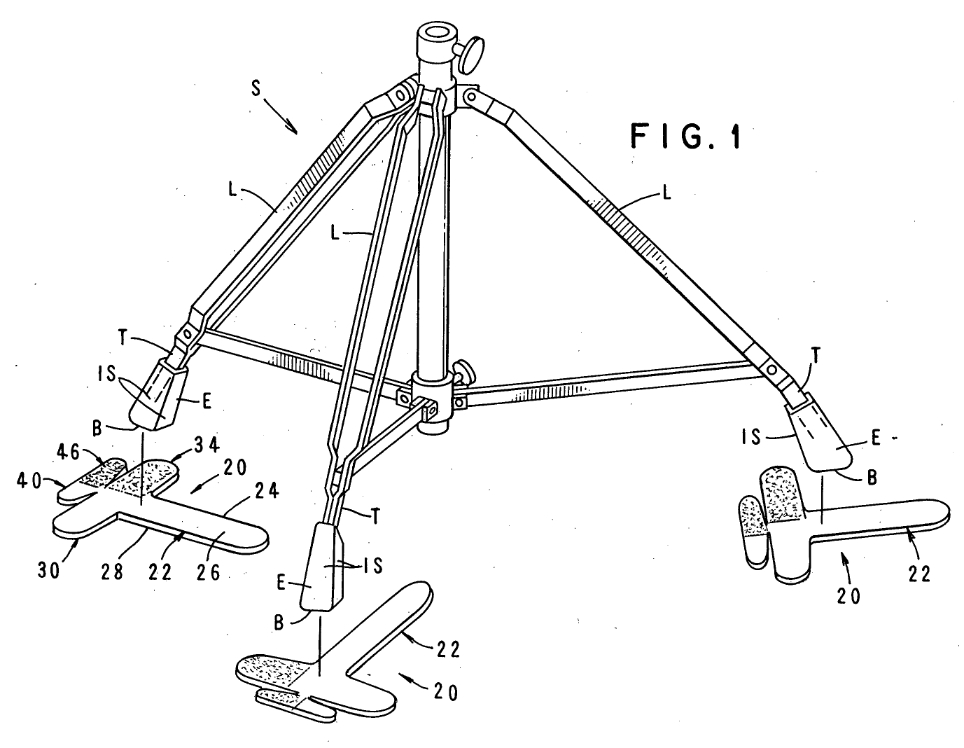

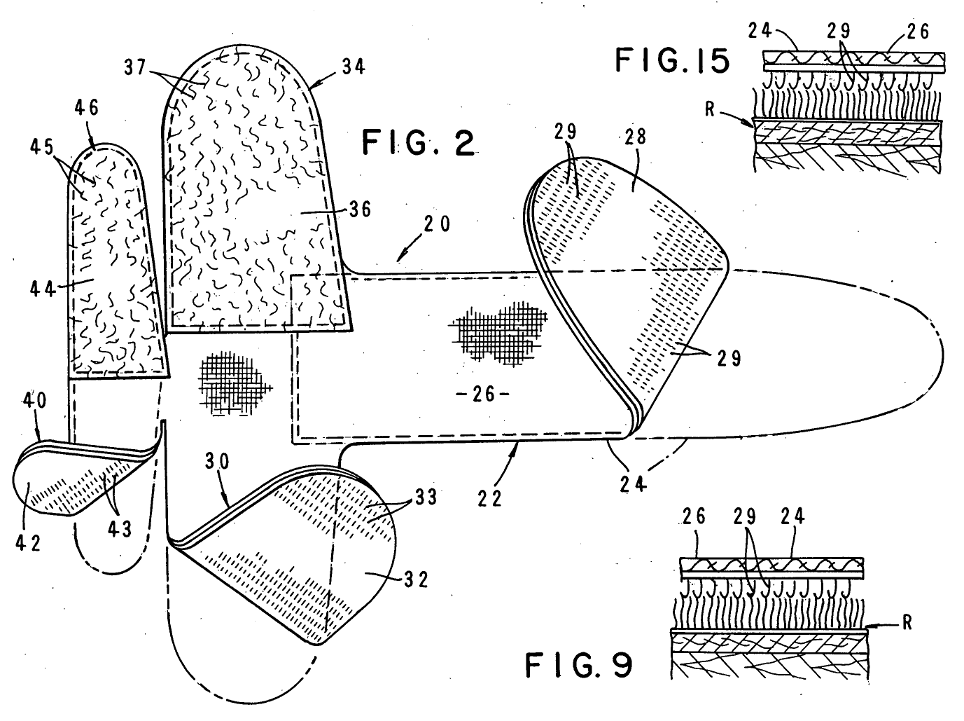

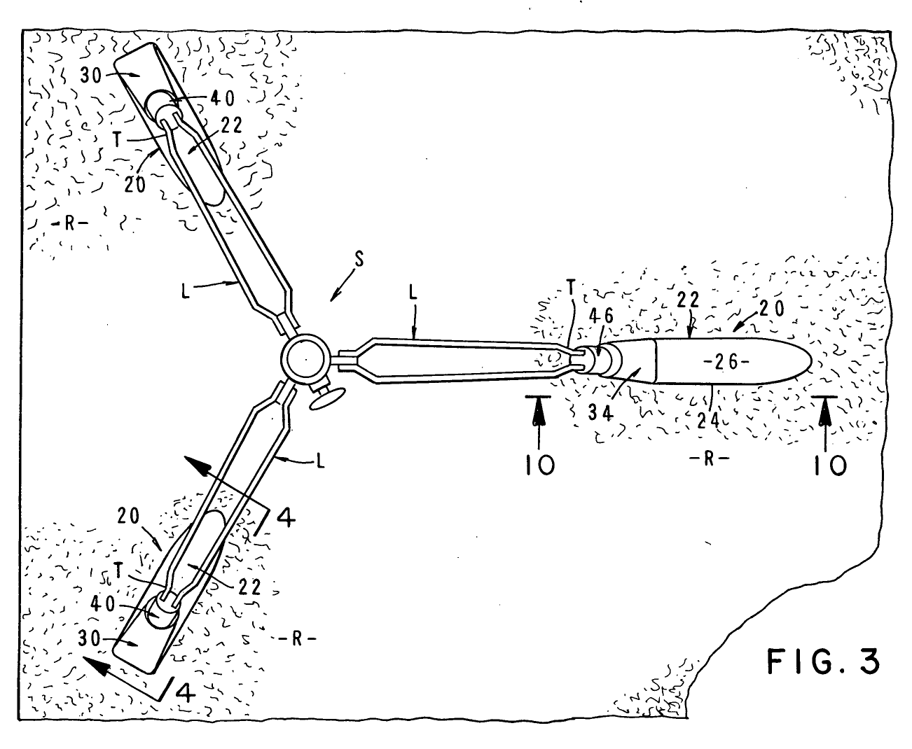

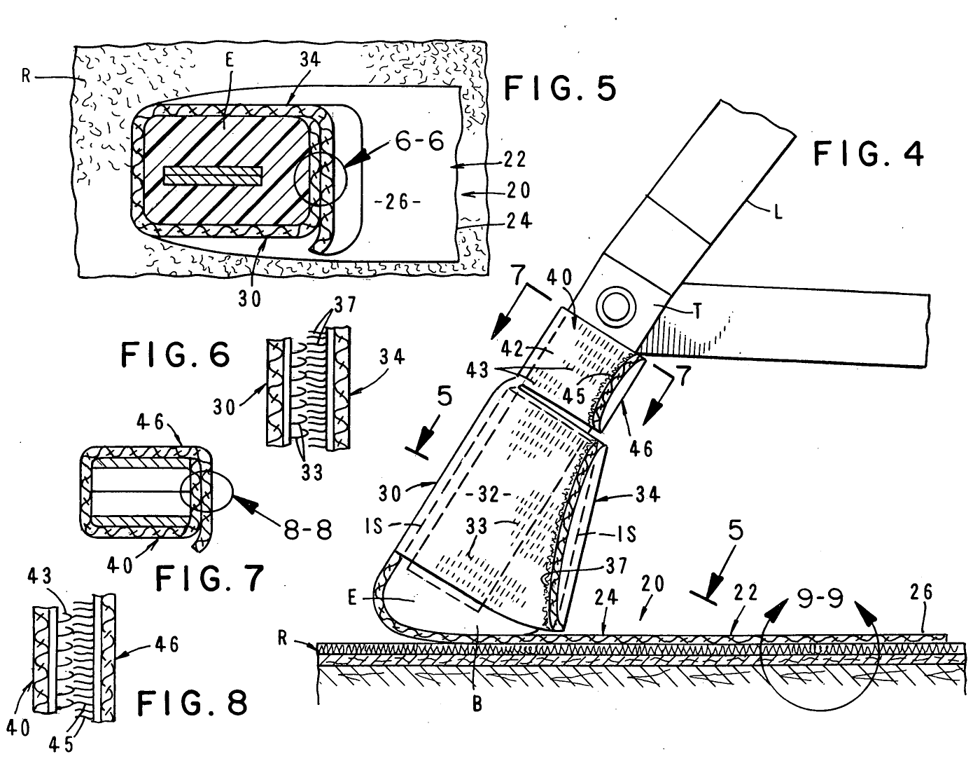

Referring to the drawings and particularly to FIGS. 1 through 4, one form of the securement device of the invention for securing in position a percussion instrument holding stand “S” is there illustrated and generally designated by the numeral 20. The instrument holding stand “S” is here shown as a tripod for holding a percussion instrument having a plurality of legs “L” with each leg having a terminal portion “T” having an enlarged extremity “E” having a rug engaging base “B” and inwardly tapering sides “IS” connected to the base. As best seen in FIGS. 1 and 2, securement device 20 here comprises a generally planar, yieldably deformable member 22, which includes an elongated segment 24 having an upper surface 26 for engagement by the base “B” of the enlarged extremity “E” of a selected one of the legs “L” of the instrument holding tripod. Segment 24 also has a lower surface 28 that is provided with gripping means, shown here as a multiplicity of small hooks 29 for releasably gripping the bandstand floor, here shown as a rug “R”.

Foldably connected to elongated segment 24 for at least partially circumscribing at least a portion of the sides of the enlarged extremity “E” of the selected one of the legs of the instrument holding tripod is a first outwardly extending segment 30. As indicated in FIG. 1, segment 30 has a surface 32 that is provided with first gripping means shown here as a multiplicity of small hooks 33 for releasably gripping an adjacent surface. Also foldably connected to elongated segment 24 for at least partially circumscribing a portion of the sides of the enlarged extremity “E” of the selected one of the legs of the instrument holding tripod and for overlying a portion of said first outwardly extending segment 30 is a second outwardly extending segment 34. As shown in FIGS. 2, 4, 5 and 6, second transversely extending segment 34 includes a surface 36 that is provided with second gripping means shown here as a multiplicity of small loops 37 for releasably gripping the first gripping means or hooks 33 of the first outwardly extending segment 30.

Foldably connected to elongated segment 30 for at least partially circumscribing a portion of the terminal portion “T” of the selected one of the legs of the instrument holding tripod is a third outwardly extending segment 40. As illustrated in FIG. 1, third transversely extending segment has a surface 42 provided with third gripping means shown here as a multiplicity of small hooks 43 for releasably gripping an adjacent surface.

Also foldably connected to elongated segment 30 for at least partially circumscribing a portion of the terminal portion “T” of the selected one of the legs of the instrument holding stand and for overlying a portion of the third outwardly extending segment 42. Fourth transversely extending segment 42 similarly includes a surface 44 provided with fourth gripping means shown here as a multiplicity of small loops 45 for releasably gripping the third gripping means or hooks 43 of third outwardly extending segment 42.

As best seen in FIG. 1 the first and second outwardly extending segments 30 and 34 have a first width, while third and fourth outwardly extending segments 40 and 42 have a second width less than said first width.

In using the securement device of the present invention, after the instrument support tripod “S” is positioned on the bandstand at the location desired by the musician, the securement device 20 is slipped under one of the tripod legs “L” in the manner shown in FIG. 8. As depicted in FIG. 8, in this position elongated segment 24 overlays the bandstand floor, or rug “R” and the multiplicity of small hooks 29 provided on the lower surface of segment 24 releasably grip the nap on the rug “R” sell as to hold segment 20 for securely in position (see FIG. 9). Next, leg 30 is wrapped around extremity “E” in the manner best seen in FIG. 5. This done, segment 34 is wrapped around extremity “E” in a manner so that it overlays a portion of segment 30. As indicated in FIG. 5, with segment 34 in this overlying position, the small hooks 43 provided on segment 34 releasably grip the small loops 43 provided on segment 40 and a manner to secure segments 30 and 34 around extremity “E”.

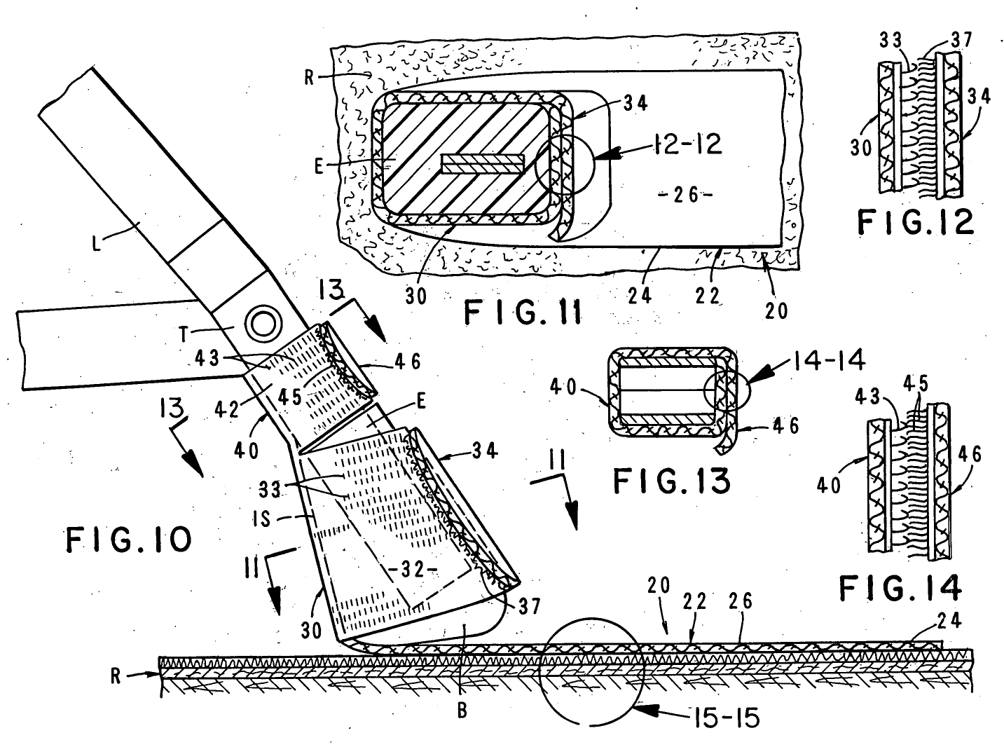

With segments 30 and 34 circumscribing extremity “E”, segment 40 is next to wrapped around terminal portion T of the selected leg and held in position until leg 42 can be wrapped around the terminal portion of the leg and positioned in an overlying relationship with respect to the segment 40 in the manner illustrated this in FIGS. 10 and 13. With the segments 30 and 34 wrapped around the terminal portion T of the selected leg, the multiplicity of small hooks 45 provided on segment 42 will releasably grip the multiplicity of small loops 43 provided on segment 40 in a manner to hold the segment's securely in position about the terminal portion of the selected leg.

When the segments 30, 34, 40 and 42 securement device interconnected with the selected leg of the tripod and with the multiplicity of books 29 formed on the lower surface of elongated segment 24 releasably gripping the bandstand rug, the instrument supporting stand “S” will be held securely in position during the playing of the instrument carried by the instrument supporting stand by the musician.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A securement device for securing in position an instrument holding stand having a plurality of legs, each terminating in a floor engaging extremity, said device comprising a generally planar, yieldably deformable member including:
(a) an elongated segment having an upper surface for engagement by the extremity of one the legs of the instrument holding stand and a lower surface having gripping means for releasably gripping the floor;
(b) a first outwardly extending segment foldably connected to said elongated segment for at least partially circumscribing a portion of one of the legs of the instrument holding stand; and
(c) a second outwardly extending segment foldably connected to said elongated segment for at least partially circumscribing a portion of one of the legs of the instrument holding stand and for overlying and releasably gripping a portion of said first outwardly extending segment.

2. The securement device as defined in claim 1, in which said first transversely extending segment has a surface provided with first gripping means for releasably gripping an adjacent surface.

3. The securement device as defined in claim 2, in which said second transversely extending segment includes a surface provided with second gripping means for releasably gripping said first gripping means of said first outwardly extending segment.

4. The securement device as defined in claim 3, further including:
(a) a third outwardly extending segment foldably connected to said elongated segment for at least partially circumscribing a portion of one of the legs of the instrument holding stand, said third transversely extending segment having a surface provided with third gripping means for releasably gripping an adjacent surface; and
(b) a fourth outwardly extending segment foldably connected to said elongated segment for at least partially circumscribing a portion of one of the legs of the instrument holding stand and for overlying a portion of said third outwardly extending segment, said fourth transversely extending segment including a surface provided with fourth gripping means for releasably gripping said third gripping means of said third outwardly extending segment.

5. The securement means as defined in claim 4 in which said first gripping means comprises a multiplicity of small hooks and in which said second gripping means comprises a multiplicity of small loops.

6. The securement device as defined in claim 5 in which said third gripping means comprises a multiplicity of small hooks and in which said fourth gripping means comprises a multiplicity of small loops.

7. The securement device as defined in claim 6 in which said first and second outwardly extending segments have a first width and in which said third and fourth outwardly extending segments have a second width less than said first width.

8. A securement device for securing in position a percussion instrument holding tripod having a plurality of legs, each leg having a tubular portion terminating in an enlarged extremity having a rug engaging base and inwardly tapering sides connected to said base, said device comprising a generally planar, yieldably deformable member including:
(a) an elongated segment having an upper surface for engagement by the base of said enlarged extremity of a selected one of the legs of the instrument holding tripod and a lower surface having gripping means for releasably gripping the rug;
(b) a first outwardly extending segment foldably connected to said elongated segment for at least partially circumscribing at least a portion of the sides of said enlarged extremity of said selected one of the legs of the instrument holding tripod, said first transversely extending segment having a surface provided with first gripping means for releasably gripping an adjacent surface;
(c) a second outwardly extending segment foldably connected to said elongated segment for at least partially circumscribing a portion of the sides of said enlarged extremity of said selected one of the legs of the instrument holding tripod and for overlying a portion of said first outwardly extending segment, said second transversely extending segment including a surface provided with second gripping means for releasably gripping said first gripping means of said first outwardly extending segment;
(d) a third outwardly extending segment foldably connected to said elongated segment for at least partially circumscribing a portion of the tubular portion of said selected one of the legs of the instrument holding tripod, said third transversely extending segment having a surface provided with third gripping means for releasably gripping an adjacent surface; and
(e) a fourth outwardly extending segment foldably connected to said elongated segment for at least partially circumscribing a portion of the tubular portion of said selected one of the legs of the instrument holding stand and for overlying a portion of said third outwardly extending segment, said fourth transversely extending segment including a surface provided with fourth gripping means for releasably gripping said third gripping means of said third outwardly extending segment.

9. The securement means as defined in claim 8 and which said first gripping means comprises a multiplicity of small hooks and in which said second gripping means comprises a multiplicity of small loops.

10. The securement device as defined in claim 8 in which said third gripping means comprises a multiplicity of small hooks and in which said fourth gripping means comprises a multiplicity of small loops.

11. The securement device as defined in claim 8 in which said first and second outwardly extending segments have a first width and in which said third and fourth outwardly extending segments have a second width less than said first width.
